(19) United States
(12) Patent Application Publication
(10) Pub. No.: US 2024/0230606 A9
(43) Pub. Date: Jul. 11, 2024

(54) FINGERPRINT SPECTRUM CONSTRUCTION METHOD FOR NEW COMPOUND ALOE CAPSULE AND FINGERPRINT SPECTRUM

(71) Applicant: SHAANXI UNIVERSITY OF SCIENCE AND TECHNOLOGY, Xi'an (CN)

(72) Inventors: Chengyuan LIANG, Xi'an (CN); Jinrong HU, Xi'an (CN); Boxin ZHANG, Xi'an (CN); Changhua KE, Xi'an (CN); Shan YANG, Xi'an (CN); Jingjing ZHOU, Xi'an (CN); Jiaxuan LI, Xi'an (CN); Qiufang XIE, Xi'an (CN); Yue GE, Xi'an (CN); Wenxue WANG, Xi'an (CN)

(21) Appl. No.: 18/381,600

(22) Filed: Oct. 18, 2023

(30) Foreign Application Priority Data
Oct. 19, 2022 (CN) 202211281891.3

(51) Int. Cl. G01N 30/86; G01N 30/14; G01N 30/72

(52) U.S. Cl. CPC G01N 30/8686; G01N 30/14; G01N 30/7233; G01N 30/8631; G01N 2030/027

(57) ABSTRACT

A fingerprint spectrum construction method for a new compound aloe capsule and a fingerprint spectrum includes: (1) taking powder of a new compound aloe capsule, carrying out reflux extraction, adding methanol, carrying out ultrasonic treatment, filtering, and taking a subsequent filtrate as a test solution; dissolving barbaloin, aloe-emodin, indirubin, tryptanthrin, aloesin, and β-sitosterol in methanol to obtain reference solutions; (2) injecting the test solution and the reference solutions into a high performance liquid chromatograph for gradient elution to obtain a chromatogram of the new compound aloe capsule and chromatograms of the reference solutions, respectively; and (3) labeling chemical components of peaks on the chromatogram of the new compound aloe capsule according to the chromatogram of the new compound aloe capsule and the chromatograms of the reference solutions to obtain a fingerprint spectrum of the new compound aloe capsule.

This application claims priority to Chinese Patent Application No. 202211281891.3, filed on Oct. 19, 2022, which is incorporated by reference for all purposes as if fully set forth herein.

### FIELD OF THE INVENTION

The present invention relates to the field of Chinese medicine testing, and specifically to a fingerprint spectrum construction method for a new compound aloe capsule and a fingerprint spectrum.

### DESCRIPTION OF THE RELATED ART

New compound aloe capsule is a Chinese medicine preparation with a long history for treating constipation. It can be dated back to a prescription recorded in Expanded Notes from the Studio of Early Enlightenment (Xianxingzhai guangbiji) by Miao Xiyong, a Chinese medical scientist in the 16th century. In 1982, Hebei Wanbang Fulin Pharmaceutical Co., Ltd. and Professor Li Enfu of Hebei Traditional Chinese Medicine Hospital jointly developed “Tongbianling Capsule”, which was renamed as “Compound Aloe Capsule” in 1994. However, because this prescription contains cinnabar which is a toxic medicinal material, and can neither be taken in large quantities nor in small quantities for a long time. To reduce the harm to human body, the toxic cinnabar was removed from the prescription, and the resultant prescription was named as “New Compound Aloe Capsule”, which is a compound preparation including aloe, indigo naturalis, and amber and has the effects of clearing away heat and moistening intestines, regulating liver and kidney, calming heart and calming nerves, etc. It is mostly used clinically for treating constipation caused by excess heat of liver meridian and stagnation of intestines, habitual constipation, dry stool, or symptoms such as abdominal distension, abdominal pain, irritability, and insomnia caused by defecation for several days.

The development of Chinese medicines is determined by the quality. At present, Chinese medicines have attracted more and more attention all over the world because of the reliable therapeutic efficacy, minimal side effects, low toxicity, and rare drug resistance. However, complex chemical components and mutual influence among the components of Chinese medicines make it difficult to control the quality of Chinese medicines. At present, the quality control of new compound aloe capsules is not strict, and existing national standards on new compound aloe capsules have requirements only on the content of barbaloin, which cannot reflect the composition of new compound aloe capsules and cannot provide a basis for the quality control and evaluation of new compound aloe capsules. Therefore, existing standards on the quality of new compound aloe capsules need to be further optimized and improved.

### SUMMARY OF THE INVENTION

An objective of the present invention is to overcome the defects in the prior art and provide a fingerprint spectrum construction method for a new compound aloe capsule and a fingerprint spectrum, to provide a comprehensive fingerprint spectrum detection method for aloe, indigo naturalis, and amber in the prescription. The detection method can objectively, comprehensively, and accurately evaluate the quality of new compound aloe capsules, and is of great significance for controlling the quality of new compound aloe capsules and ensuring the clinical efficacy.

The present invention is accomplished through the following technical solutions:

A fingerprint spectrum construction method for a new compound aloe capsule, including:
(1) taking powder of a new compound aloe capsule, carrying out reflux extraction, adding methanol, carrying out ultrasonic treatment, filtering, and taking a subsequent filtrate as a test solution; respectively dissolving barbaloin, aloe-emodin, indirubin, tryptanthrin, aloesin, and β-sitosterol in methanol to obtain reference solutions;
(2) respectively injecting the test solution and the reference solutions into a high performance liquid chromatograph for gradient elution to obtain a chromatogram of the new compound aloe capsule and chromatograms of the reference solutions; and
(3) labeling chemical components of peaks on the chromatogram of the new compound aloe capsule according to the chromatogram of the new compound aloe capsule and the chromatograms of the reference solutions to obtain a fingerprint spectrum of the new compound aloe capsule.

Preferably, in the step (2), a mobile phase used in the gradient elution includes: acetonitrile and 0.08% aqueous phosphoric acid solution.

Further, in the step (2), an elution procedure is shown in a table below:

| Time | | 0.08% aqueous phosphoric |
|---|---|---|
| (min) | Acetonitrile | acid solution |
| 0-5 | 10 | 90 |
| 5-15 | 15 | 85 |
| 15-20 | 20 | 80 |
| 20-30 | 25 | 75 |
| 30-40 | 30 | 70 |
| 40-50 | 40 | 60 |
| 50-60 | 50 | 50 |

Preferably, in the step (2), the chromatograms are determined at a wavelength of 300 nm.

Preferably, in the step (2), a chromatographic column used in the high performance liquid chromatograph is Hypersil ODS (C18).

Preferably, the method further includes: carrying out mass spectrometry analysis on the test solution to obtain a mass spectrum,

wherein in the step (3), the chemical components of the peaks on the chromatogram of the new compound aloe capsule are labeled according to the chromatogram of the new compound aloe capsule, the chromatograms of the reference solutions, and the mass spectrum, to obtain the fingerprint spectrum of the new compound aloe capsule.

Preferably, the method further includes: obtaining chromatograms of different batches of new compound aloe capsules and importing the chromatograms into a similarity evaluation system for chromatographic fingerprint spectra of Chinese medicines, selecting chromatographic peaks existing in all the chromatograms of the different batches of new compound aloe capsules as common peaks, calculating a relative retention time and a relative peak area of each of the common peaks, generating a reference fingerprint spectrum, and labeling chemical components of the common peaks in the reference fingerprint spectrum according to retention times in the chromatograms of the reference solutions; and calculating a similarity between the fingerprint spectrum of the new compound aloe capsule and the reference fingerprint spectrum, to determine reliability of the fingerprint spectrum of the new compound aloe capsule.

Preferably, the fingerprint spectrum of the new compound aloe capsule has six characteristic peaks, including peak 4, peak 5, peak 6, peak 8, peak 14 and peak 15, respectively corresponding to tryptanthrin, aloesin, barbaloin, β-sitosterol, aloe-emodin, and indirubin.

A fingerprint spectrum of a new compound aloe capsule obtained by the construction method.

Compared with the prior art, the present invention has the following beneficial effects.

In the present invention, high performance liquid chromatography is used to construct a fingerprint spectrum of a new compound aloe capsule. Through screening of extraction methods, a fingerprint spectrum determination method is established. The obtained chromatogram has good peak characteristics such as peak shape and separation degree. The present invention requires simple steps and low costs and meets the requirements for fingerprint spectrum construction. The method of the present invention features simple operation, high stability and reliability, high precision, and good separation degree, and the obtained fingerprint spectrum has high stability and reproducibility. The use of fingerprint spectra as a quality control method for new compound aloe capsules avoids the inaccurate determination of the overall quality of the preparation by measuring only one or two chemical components, allows for a more comprehensive and scientific evaluation of the quality of new compound aloe capsules to ensure the quality and clinical efficacy of the product, and is of great significance to the component identification, quality evaluation, and quality standard formulation of new compound aloe capsules.

Further, acetonitrile and 0.08% aqueous phosphoric acid solution are used in the present invention, the fingerprint spectrum of the new compound aloe capsule is constructed using a gradient elution method, and the elution procedure of the present invention provides good peak characteristics and good separation degree.

Further, because the fingerprint spectrum is not for determining the precise content of a component, but for fully reflecting information of chemical components, the determination is carried out at a wavelength of 300 nm in present invention, so that more peaks are obtained and more complete information is reflected, with good absorption peaks and stable baseline.

Further, the mass spectrometry analysis on the test solution can supplement more chemical components in the fingerprint spectrum and make the analysis more comprehensive.

Further, the quality of new compound aloe capsules can be evaluated more comprehensively and scientifically through the systematic analysis of multiple batches of samples, thereby ensuring the quality and clinical efficacy of the product.

### BRIEF DESCRIPTION OF THE DRAWINGS

FIG. 1 is a chromatogram obtained by an extraction method A and an elution procedure C according to the present invention.

FIG. 2 is a chromatogram obtained by an extraction method B and an elution procedure C according to the present invention.

FIG. 3 is a chromatogram obtained by an extraction method C and an elution procedure C according to the present invention.

FIG. 4 is a chromatogram obtained by an extraction method D and an elution procedure A according to the present invention.

FIG. 5 is a chromatogram obtained by an extraction method D and an elution procedure B according to the present invention.

FIG. 6 is a chromatogram obtained by an extraction method D and an elution procedure C according to the present invention.

FIG. 7 is a chromatogram of a barbaloin reference substance according to the present invention.

FIG. 8 is a chromatogram of an aloe-emodin reference substance according to the present invention.

FIG. 9 is a chromatogram of an indirubin reference substance according to the present invention.

FIG. 10 is a mass spectrum of tryptanthrin according to the present invention.

FIG. 11 is a mass spectrum of aloesin according to the present invention.

FIG. 12 is a mass spectrum of β-sitosterol according to the present invention.

FIG. 13 shows fingerprint spectra of 12 batches of test samples of aloe, indigo naturalis, and amber in new compound aloe capsules according to the present invention.

### DETAILED DESCRIPTION OF THE PREFERRED EMBODIMENTS

In order for those skilled in the art to better understand the present invention, the technical solutions in the embodiments of the present invention will be described clearly and fully with reference to the accompanying drawings in the embodiments of the present invention. Apparently, the embodiments described are merely some embodiments, rather than all of the embodiments of the present invention. All other embodiments obtained by a person of ordinary skill in the art without creative efforts based on the embodiments of the present invention shall fall within the protection scope of the present invention.

It should be noted that in the specification, claims, and accompanying drawings of the embodiments of the present invention, the terms “first”, “second” or the like are intended to distinguish between similar objects but do not indicate a particular order or sequence. It is to be understood that the data termed in such a way are interchangeable in appropriate circumstances, so that the embodiments of the present invention described herein can be implemented in orders other than the order illustrated or described herein. Moreover, the terms “include,” “comprise,” and any other variants thereof mean are intended to cover a non-exclusive inclusion. For example, a process, method, system, product, or device that includes a list of steps or units is not necessarily limited to those expressly listed steps or units, but may include other steps or units not expressly listed or inherent to such a process, method, product, or device.

1. A fingerprint spectrum construction method for a new compound aloe capsule includes the following steps.
(1) Preparation of test solution: Different batches of new compound aloe capsule powders are each accurately weighed and subjected to reflux extraction. After cooling to room temperature, ultra-pure water is added to make up the weight loss, followed by addition of methanol, ultrasonic treatment, and filtering. A subsequent filtrate is taken as a test solution.
(2) Preparation of reference solutions: Barbaloin, aloe-emodin, indirubin, tryptanthrin, aloesin, and β-sitosterol dried to a constant weight are accurately weighed and respectively placed in volumetric flasks, followed by addition of methanol to make up the volume to the mark, to respectively prepare reference solutions, which are stored at 4° C.
(3) The test solution and the reference solutions are accurately weighed, filtered through a 0.45 μm microporous filter membrane, and respectively injected into a high performance liquid chromatograph, and chromatograms are recorded to obtain a chromatogram of the new compound aloe capsule and chromatograms of the reference solutions.
(4) To determine and supplement more chemical components in the fingerprint spectrum, mass spectrometry analysis is carried out on the test solution to obtain a total ion chromatogram and mass spectra of six chemical components. The test data is imported into Xcalibur software and Qual Browser is opened to carry out a data analysis of peak characteristics of chemical components.
(5) Chemical components of peaks on the chromatogram of the new compound aloe capsule are labeled according to the chromatogram and the mass spectra of the new compound aloe capsule and the chromatograms of the reference solutions to obtain a fingerprint spectrum of the new compound aloe capsule.
(6) The chromatogram of the test solution of the new compound aloe capsule is exported and imported into a similarity evaluation system (2004A version) for chromatographic fingerprint spectra of Chinese medicines, chromatographic peaks existing in all the chromatograms of the different batches of new compound aloe capsules are selected as common peaks, a relative retention time and a relative peak area of each of the common peaks are calculated, a reference fingerprint spectrum is generated, and chemical components of the common peaks in the reference fingerprint spectrum are labeled according to retention times in the chromatograms of the individual reference solutions.
(7) A similarity between the fingerprint spectrum of the new compound aloe capsule and the reference fingerprint spectrum is calculated, to determine reliability of the fingerprint spectrum of the new compound aloe capsule.

In the step (1), the test solution is preferably prepared by the following method: accurately weighing 1.0 g of each of 12 batches of new compound aloe capsule powders, placing each of the powders in a conical flask with a stopper, adding 30 mL of ultra-pure water to dissolve the powder, weighing, carrying out reflux extraction at 115° C. for 30 min, cooling to room temperature, weighing again, adding ultra-pure water to make up the weight loss, adding 20 mL of methanol, carrying out ultrasonic treatment for 30 min, filtering, and taking the subsequent filtrate as the test solution.

In the step (2), 5 mg of each of barbaloin, aloe-emodin, indirubin, tryptanthrin, aloesin, and β-sitosterol dried to a constant weight is accurately weighed.

In the step (3), separation conditions of the high performance liquid chromatography are as follows:
Chromatographic column: Hypersil ODS (C18)
Column temperature: 30° C.
Detection wavelength: 300 nm
Flow rate: 0.8 mL/min
Sample size: 20 μL
Mobile phase: Acetonitrile (phase A) and 0.08% aqueous phosphoric acid solution (phase B)

The elution procedure is shown in Table 3 below.

The step 5 may be carried out by a DIONEX UltiMate 3000 ultra performance liquid chromatography-Orbitrap mass spectrometer under test conditions including electrospray ionization (ESI), a spray voltage of 3500 V, a sheath gas flow rate of 40 arb, an auxiliary gas flow rate of 10 arb, an auxiliary air temperature of 300° C., a capillary temperature of 300° C., a full scan mode, and a mass-to-charge ratio m/z of 100-1300.

2. Optimization of Extraction Method

In the step (1) of the present invention, the following four extraction methods are respectively investigated.

Extraction method A: 1.0 g of the new compound aloe capsule powder is accurately weighed and placed in a conical flask with a stopper, dissolved by adding 25 mL of N,N-dimethylformamide (DMF), ultrasonically extracted for 1 h, cooled to room temperature, and filtered. 10 mL of the subsequent filtrate is taken, diluted by ultra-pure water added in an amount which is 5 times that of the subsequent filtrate, and extracted twice with 20 mL of ethyl acetate. The extracts are combined to obtain the test solution.

Extraction method B: 1.0 g of the new compound aloe capsule powder is accurately weighed and placed in a conical flask with a stopper, dissolved by adding 25 mL of methanol, ultrasonically extracted for 1 h, cooled to room temperature, and filtered. 10 mL of the subsequent filtrate is taken, diluted by ultra-pure water added in an amount which is 5 times that of the subsequent filtrate, and extracted twice with 20 mL of ethyl acetate. The extracts are combined to obtain the test solution.

Extraction method C: 1.0 g of the new compound aloe capsule powder is accurately weighed and placed in a conical flask with a stopper, dissolved by adding 25 mL of ultra-pure water, ultrasonically extracted for 1 h, cooled to room temperature, and filtered. 10 mL of the subsequent filtrate is taken, diluted by ultra-pure water added in an amount which is 5 times that of the subsequent filtrate, and extracted twice with 20 mL of ethyl acetate. The extracts are combined to obtain the test solution.

Extraction method D: 1.0 g of the new compound aloe capsule powder is accurately weighed, placed in a conical flask with a stopper, dissolved by adding 30 mL of ultra-pure water, weighed, subjected to reflux extraction at 115° C. for 30 min, cooled to room temperature, and weighed again, followed by addition of ultra-pure water to make up the weight loss, addition of 20 mL of methanol, ultrasonic treatment for 30 min, and filtering. The subsequent filtrate is taken as the test solution.

The results show that the peak characteristics of the extraction method A are not good, the number of peaks is small, and the separation degree between adjacent peaks is low, failing to meet fingerprint spectrum requirements. Compared with the method A, for the extraction method B, the number of peaks is increased, the peaks are mainly concentrated in 35-56 min, the separation degree is relatively good, but there is no peak before 10-35 min. Compared with the extraction methods A and B, the extraction methods C and D provide good peak characteristics such as peak shape and separation degree. Compared with the extraction method C, the extraction method D involves simpler steps and lower costs. Therefore, the extraction method D is determined as the final extraction condition for fingerprint spectrum construction. To be specific, 1.0 g of the new compound aloe capsule powder is accurately weighed, placed in a conical flask with a stopper, dissolved by adding 30 mL of ultra-pure water, weighed, subjected to reflux extraction at 115° C. for 30 min, cooled to room temperature, and weighed again, followed by addition of ultra-pure water to make up the weight loss, addition of 20 mL of methanol, ultrasonic treatment for 30 min, and filtering. The subsequent filtrate is taken as the test solution.

3. Optimization of Mobile Phase Elution Procedure

In the step (3) of the present invention, the following three mobile phase elution procedures are respectively investigated.

TABLE 1
Elution procedure A:

| Time | Acetonitrile | 0.08% aqueous phosphoric |
|---|---|---|
| (min) | (phase A) | acid solution (phase B) |
| 0-10 | 20 | 80 |
| 10-15 | 25 | 75 |
| 15-20 | 30 | 70 |
| 20-25 | 38 | 62 |
| 25-30 | 45 | 55 |
| 30-45 | 55 | 45 |
| 45-60 | 65 | 35 |

TABLE 2
Elution procedure B:

| Time | Acetonitrile | 0.08% aqueous phosphoric |
|---|---|---|
| (min) | (phase A) | acid solution (phase B) |
| 0-5 | 10 | 90 |
| 5-15 | 20 | 80 |
| 15-20 | 25 | 75 |
| 20-30 | 30 | 70 |
| 30-35 | 35 | 65 |
| 35-40 | 40 | 60 |
| 40-45 | 45 | 55 |

TABLE 3
Elution procedure C:

| Time | Acetonitrile | 0.08% aqueous phosphoric |
|---|---|---|
| (min) | (phase A) | acid solution (phase B) |
| 0-5 | 10 | 90 |
| 5-15 | 15 | 85 |
| 15-20 | 20 | 80 |
| 20-30 | 25 | 75 |
| 30-40 | 30 | 70 |
| 40-50 | 40 | 60 |
| 50-60 | 50 | 50 |

The results showed that for the elution procedure A, although there are peaks in 32-55 min, the total number of peaks is small, the separation degree is poor, and there is no peak in 0-30 min. Compared with the chromatogram in Example 4, for the elution procedure B, after organic phases are reduced, the peak spacing is slightly reduced in 20-40 min, but the number of peaks is still small and the separation degree is still poor. Compared with the elution procedures A and B, the elution procedure C provides good peak characteristics and good separation degree. Therefore, the elution procedure C is selected as the final mobile phase elution procedure for fingerprint spectrum construction.

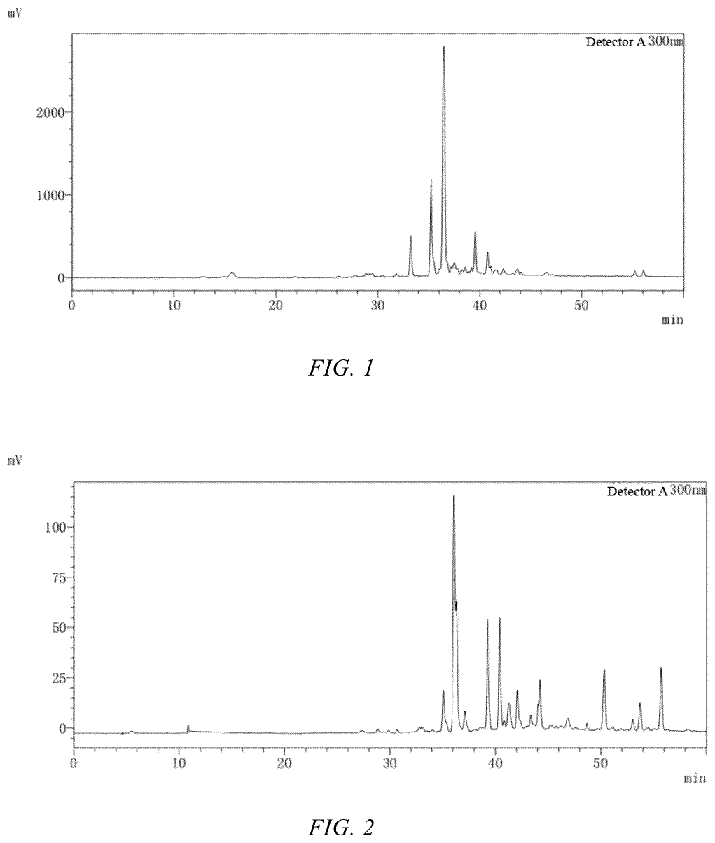

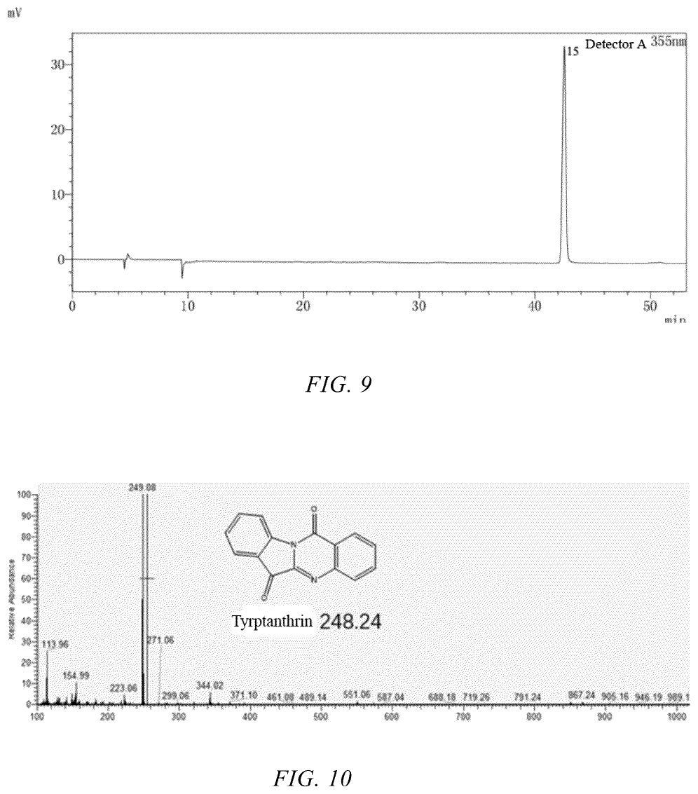

The present invention will be further described in detail below with reference to FIG. 1 to FIG. 13.

1. Instruments Used in the Present Invention are Shown in Table 4 Below.

TABLE 4
Instruments used in the present invention

| Instrument name | Model | Manufacturer |
|---|---|---|
| High performance | LC-16 | Shimadzu (China) |
| liquid chromatograph | | |
| Chromatographic | Hypersil ODS (C18) | Elitehplc |
| column | KromasiL100-5-C18 | AkzoNobel |
| | NewmateTM C18 | Welch |
| Electronic balance | JA2603B | Techcomp Precision Balances |
| | | (Shanghai) Co., Ltd. |
| Electronic balance | LE204E/02 | Mettler Toledo Instruments |
| | | (Shanghai) Co., Ltd. |
| Electronic balance | JCS-600 | Kaifeng Group Co., Ltd. |
| Ultrasonic cleaner | YM-1005 (44 KHz) | Shenzhen Fangao |
| | | Microelectronics Co., Ltd. |
| Ultra-pure water | Millipore Milli-v Plus | Millipore, Bedford, MA, USA |
| preparation system | | |
| Digital display | HH-8 | Jintan Jiangnan |
| thermostat water bath | | Instrument Factory |

2. Materials and reagents used in the present invention are shown in Table 5 below.

TABLE 5
Materials and reagents used in the present invention

| Name | Batch number/purity | Manufacturer |
|---|---|---|
| New compound | LH210901 | Hebei Wanbang Folon |
| aloe capsule | LH210902 | Pharmaceutical Co., Ltd. |
| | LH210903 | |
| | LH210904 | |
| | LH210905 | |
| | LH210906 | |
| | LH210907 | |
| | LH210908 | |
| | LH210909 | |
| | LH210910 | |
| | LH210911 | |
| | LH210912 | |
| Barbaloin standard | 110787-201808/HPLC ≥ 98% | China National Institutes |
| Aloe-emodin standard | | for Food and Drug Control |
| Indirubin standard | LE662/HPLC ≥ 98% | China National Institutes |
| | | for Food and Drug Control |
| | I521350/HPLC ≥ 98% | China National Institutes |
| | | for Food and Drug Control |
| Tryptanthrin standard | VIP(CT)703311/HPLC ≥ 98% | China National Institutes |
| | | for Food and Drug Control |
| Aloesin standard | BTLA- | China National Institutes |
| | 184001/HPLC ≥ 98% | for Food and Drug Control |
| β-sitosterol standard | UP1612947/HPLC ≥ 98% | China National Institutes |
| | | for Food and Drug Control |
| Methanol | Chromatographic grade | Fisher Scientific |
| Acetonitrile | Chromatographic grade | Fisher Scientific |
| Phosphoric acid | Chromatographic grade | Tianjin Tianli Chemical |
| | | Reagent Co., Ltd. |
| Methanol | Analytical grade | Tianjin Tianli Chemical |
| | | Reagent Co., Ltd. |
| Phosphoric acid | Analytical grade | Tianjin Tianli Chemical |
| | | Reagent Co., Ltd. |
| DMF | Analytical grade | Tianjin Tianli Chemical |
| | | Reagent Co., Ltd. |

### Example 1

(1) Preparation of test solution: The test solution was prepared according to the extraction method A. To be specific, 1.0 g of each of 12 batches of new compound aloe capsule powders was accurately weighed and placed in a conical flask with a stopper, dissolved by adding 25 mL of N,N-dimethylformamide (DMF), ultrasonically extracted for 1 h, cooled to room temperature, and filtered. 10 mL of the subsequent filtrate was taken, diluted by ultra-pure water added in an amount which was 5 times that of the subsequent filtrate, and extracted twice with 20 mL of ethyl acetate. The extracts were combined to obtain the test solution.
(2) Preparation of reference solutions: 5 mg of each of barbaloin, aloe-emodin, indirubin, tryptanthrin, aloesin, and β-sitosterol dried to a constant weight was accurately weighed and respectively placed in a 50 mL volumetric flask, followed by addition of methanol to make up the volume to the mark, to respectively prepare standard stock solutions, which were stored at 4° C.
(3) Construction of fingerprint spectrum: The test solution and the reference solutions were accurately weighed, filtered through a 0.45 μm microporous filter membrane, and respectively injected into a high performance liquid chromatograph, and chromatograms were recorded.

Separation conditions of the high performance liquid chromatography were as follows:
Chromatographic column: Hypersil ODS (C18)
Column temperature: 30° C.
Detection wavelength: 300 nm
Flow rate: 0.8 mL/min
Sample size: 20 μL
Mobile phase: Acetonitrile (phase A) and 0.08% aqueous phosphoric acid solution (phase B)

Elution procedure: The elution procedure C was adopted.

The final chromatogram obtained was shown in FIG. 1. As can be seen from the chromatogram, the peak characteristics of the extraction method A in this embodiment were not good, the number of peaks was small, and the separation degree between adjacent peaks was low, failing to meet fingerprint spectrum requirements.

### Example 2

(1) Preparation of test solution: The test solution was prepared according to the extraction method B. To be specific, 1.0 g of each of 12 batches of new compound aloe capsule powders was accurately weighed and placed in a conical flask with a stopper, dissolved by adding 25 mL of methanol, ultrasonically extracted for 1 h, cooled to room temperature, and filtered. 10 mL of the subsequent filtrate was taken, diluted by ultra-pure water added in an amount which was 5 times that of the subsequent filtrate, and extracted twice with 20 mL of ethyl acetate. The extracts were combined to obtain the test solution.

(2) Preparation of reference solutions: 5 mg of each of barbaloin, aloe-emodin, indirubin, tryptanthrin, aloesin, and β-sitosterol dried to a constant weight was accurately weighed and respectively placed in a 50 mL volumetric flask, followed by addition of methanol to make up the volume to the mark, to respectively prepare standard stock solutions, which were stored at 4° C.

(3) Construction of fingerprint spectrum: The test solution and the reference solutions were accurately weighed, filtered through a 0.45 μm microporous filter membrane, and respectively injected into a high performance liquid chromatograph, and chromatograms were recorded.

Separation conditions of the high performance liquid chromatography were as follows:
Chromatographic column: Hypersil ODS (C18)
Column temperature: 30° C.
Detection wavelength: 300 nm
Flow rate: 0.8 mL/min
Sample size: 20 μL
Mobile phase: Acetonitrile (phase A) and 0.08% aqueous phosphoric acid solution (phase B)

Elution procedure: The elution procedure C was adopted.

The final chromatogram obtained was shown in FIG. 2. As can be seen from the chromatogram, compared with the method A in Example 1, for the extraction method B in this embodiment, the number of peaks was increased, the peaks were mainly concentrated in 35-56 min, the separation degree was relatively good, but there was no peak before 10-35 min.

### Example 3

(1) Preparation of test solution: The test solution was prepared according to the extraction method C. To be specific, 1.0 g of each of 12 batches of new compound aloe capsule powders was accurately weighed and placed in a conical flask with a stopper, dissolved by adding 25 mL of ultra-pure water, ultrasonically extracted for 1 h, cooled to room temperature, and filtered. 10 mL of the subsequent filtrate was taken, diluted by ultra-pure water added in an amount which was 5 times that of the subsequent filtrate, and extracted twice with 20 mL of ethyl acetate. The extracts were combined to obtain the test solution.

(2) Preparation of reference solutions: 5 mg of each of barbaloin, aloe-emodin, indirubin, tryptanthrin, aloesin, and β-sitosterol dried to a constant weight was accurately weighed and respectively placed in a 50 mL volumetric flask, followed by addition of methanol to make up the volume to the mark, to respectively prepare standard stock solutions, which were stored at 4° C.

(3) Construction of fingerprint spectrum: The test solution and the reference solutions were accurately weighed, filtered through a 0.45 μm microporous filter membrane, and respectively injected into a high performance liquid chromatograph, and chromatograms were recorded.

Separation conditions of the high performance liquid chromatography were as follows:
Chromatographic column: Hypersil ODS (C18)
Column temperature: 30° C.
Detection wavelength: 300 nm
Flow rate: 0.8 mL/min
Sample size: 20 μL
Mobile phase: Acetonitrile (phase A) and 0.08% aqueous phosphoric acid solution (phase B)

Elution procedure: The elution procedure C was adopted.

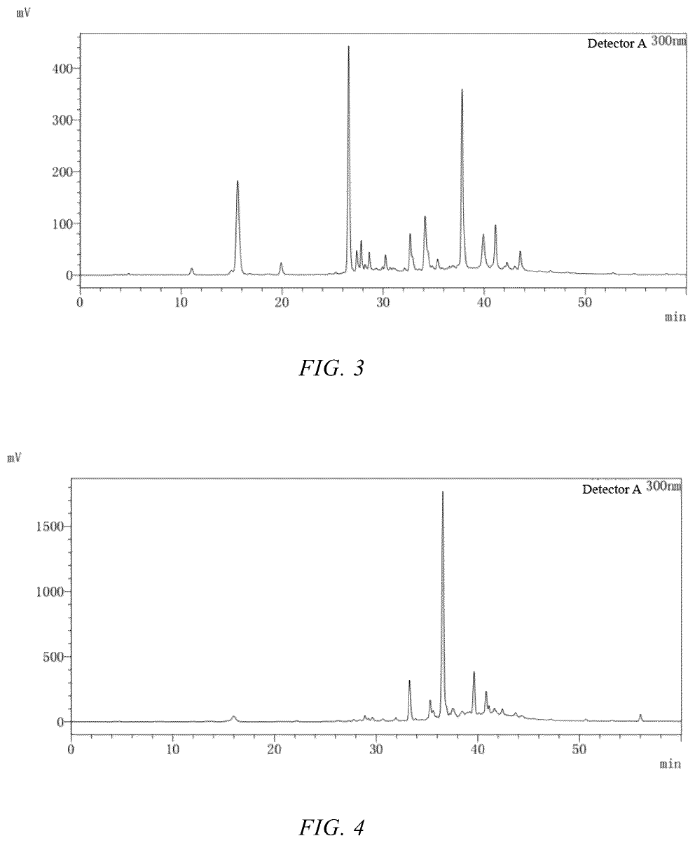

The final chromatogram obtained was shown in FIG. 3. As can be seen from the chromatogram, compared with the extraction methods A and B in Examples 1 and 2, the extraction method C in this embodiment provided good peak characteristics such as good peak shape and good separation degree.

### Example 4

(1) Preparation of test solution: The test solution was prepared according to the extraction method D. To be specific, 1.0 g of each of 12 batches of new compound aloe capsule powders was accurately weighed, placed in a conical flask with a stopper, dissolved by adding 30 mL of ultra-pure water, weighed, subjected to reflux extraction at 115° C. for 30 min, cooled to room temperature, and weighed again, followed by addition of ultra-pure water to make up the weight loss, addition of 20 mL of methanol, ultrasonic treatment for 30 min, and filtering. The subsequent filtrate was taken as the test solution.

(2) Preparation of reference solutions: 5 mg of each of barbaloin, aloe-emodin, indirubin, tryptanthrin, aloesin, and β-sitosterol dried to a constant weight was accurately weighed and respectively placed in a 50 mL volumetric flask, followed by addition of methanol to make up the volume to the mark, to respectively prepare standard stock solutions, which were stored at 4° C.

(3) Construction of fingerprint spectrum: The test solution and the reference solutions were accurately weighed, filtered through a 0.45 μm microporous filter membrane, and respectively injected into a high performance liquid chromatograph, and chromatograms were recorded.

Separation conditions of the high performance liquid chromatography were as follows:
Chromatographic column: Hypersil ODS (C18)
Column temperature: 30° C.
Detection wavelength: 300 nm
Flow rate: 0.8 mL/min
Sample size: 20 μL
Mobile phase: Acetonitrile (phase A) and 0.08% aqueous phosphoric acid solution (phase B)

Elution procedure: The elution procedure A was adopted.

The final chromatogram obtained was shown in FIG. 4. As can be seen from the chromatogram, for the elution procedure A in this embodiment, although there were peaks in 32-55 min, the total number of peaks was small, the separation degree was poor, and there was no peak in 0-30 min.

### Example 5

(1) Preparation of test solution: The test solution was prepared according to the extraction method D. To be specific, 1.0 g of each of 12 batches of new compound aloe capsule powders was accurately weighed, placed in a conical flask with a stopper, dissolved by adding 30 mL of ultra-pure water, weighed, subjected to reflux extraction at 115° C. for 30 min, cooled to room temperature, and weighed again, followed by addition of ultra-pure water to make up the weight loss, addition of 20 mL of methanol, ultrasonic treatment for 30 min, and filtering. The subsequent filtrate was taken as the test solution.

(2) Preparation of reference solutions: 5 mg of each of barbaloin, aloe-emodin, indirubin, tryptanthrin, aloesin, and β-sitosterol dried to a constant weight was accurately weighed and respectively placed in a 50 mL volumetric flask, followed by addition of methanol to make up the volume to the mark, to respectively prepare standard stock solutions, which were stored at 4° C.

(3) Construction of fingerprint spectrum: The test solution and the reference solutions were accurately weighed, filtered through a 0.45 μm microporous filter membrane, and respectively injected into a high performance liquid chromatograph, and chromatograms were recorded.

Separation conditions of the high performance liquid chromatography were as follows:
Chromatographic column: Hypersil ODS (C18)
Column temperature: 30° C.
Detection wavelength: 300 nm
Flow rate: 0.8 mL/min
Sample size: 20 μL
Mobile phase: Acetonitrile (phase A) and 0.08% aqueous phosphoric acid solution (phase B)

Elution procedure: The elution procedure B was adopted.

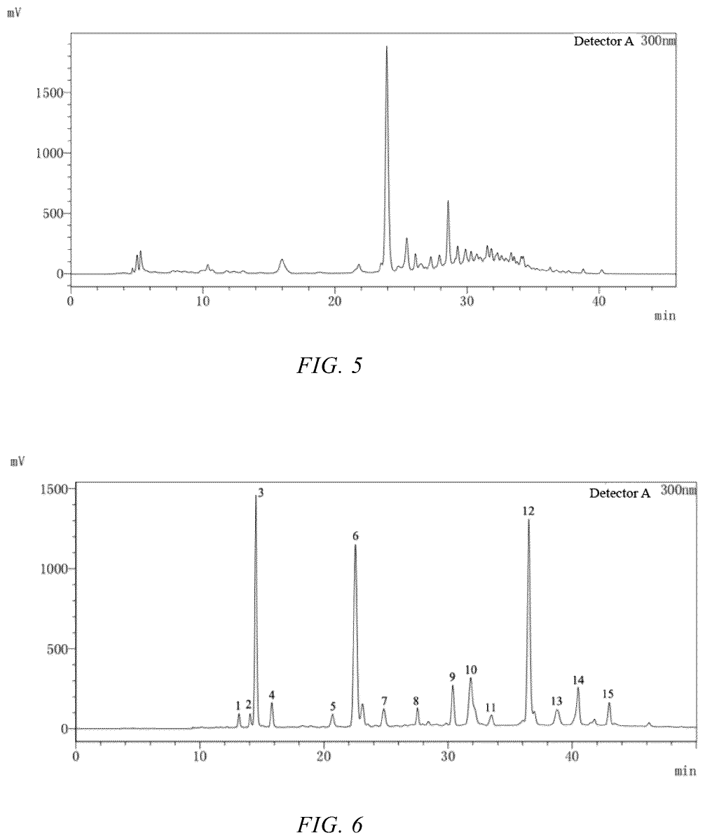

The final chromatogram obtained was shown in FIG. 5. As can be seen from the chromatogram, compared with the chromatogram in Example 4, for the elution procedure B in this embodiment, after organic phases were reduced, the peak spacing was slightly reduced in 20-40 min, but the number of peaks was still small and the separation degree was still poor.

### Example 6

(1) Preparation of test solution: The test solution was prepared according to the extraction method D. To be specific, 1.0 g of each of 12 batches of new compound aloe capsule powders was accurately weighed, placed in a conical flask with a stopper, dissolved by adding 30 mL of ultra-pure water, weighed, subjected to reflux extraction at 115° C. for 30 min, cooled to room temperature, and weighed again, followed by addition of ultra-pure water to make up the weight loss, addition of 20 mL of methanol, ultrasonic treatment for 30 min, and filtering. The subsequent filtrate was taken as the test solution.

(2) Preparation of reference solutions: 5 mg of each of barbaloin, aloe-emodin, indirubin, tryptanthrin, aloesin, and β-sitosterol dried to a constant weight was accurately weighed and respectively placed in a 50 mL volumetric flask, followed by addition of methanol to make up the volume to the mark, to respectively prepare standard stock solutions, which were stored at 4° C.

(3) Construction of fingerprint spectrum: The test solution and the reference solutions were accurately weighed, filtered through a 0.45 μm microporous filter membrane, and respectively injected into a high performance liquid chromatograph, and chromatograms were recorded.

Separation conditions of the high performance liquid chromatography were as follows:
Chromatographic column: Hypersil ODS (C18)
Column temperature: 30° C.
Detection wavelength: 300 nm
Flow rate: 0.8 mL/min
Sample size: 20 μL
Mobile phase: Acetonitrile (phase A) and 0.08% aqueous phosphoric acid solution (phase B)

The elution procedure C was adopted.

The final chromatogram obtained was shown in FIG. 6. The chromatogram obtained by the extraction method D and the elution procedure C in this embodiment had good peak characteristics and good separation degree, and met the requirements for fingerprint spectrum construction. Compared with the extraction method C, the extraction method D involved simpler steps and lower costs. Therefore, this method was finally selected as a method for constructing a fingerprint spectrum of a new compound aloe capsule, and the follow-up peak identification, similarity analysis, and methodological investigation were carried out.

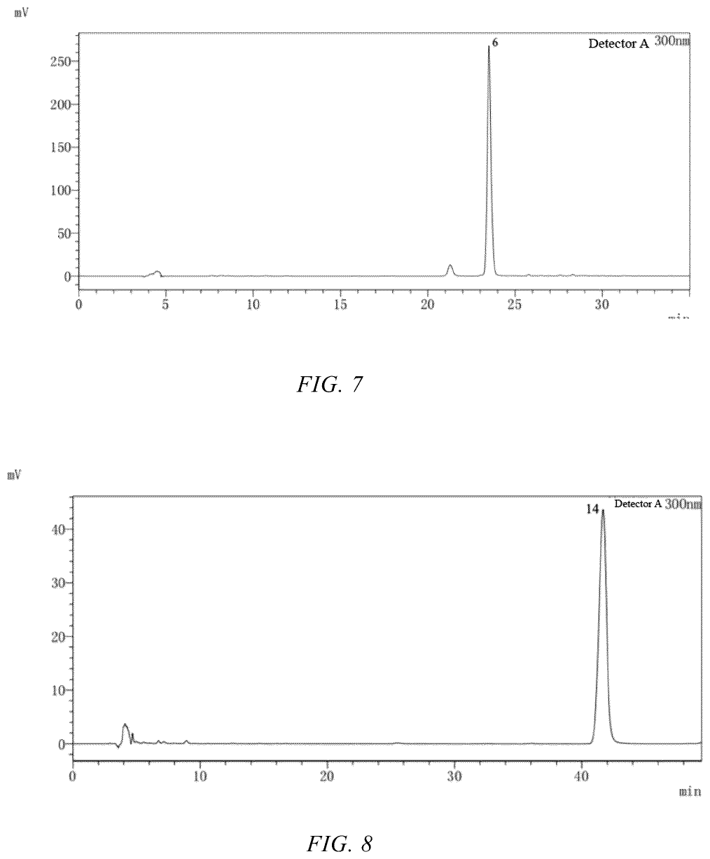

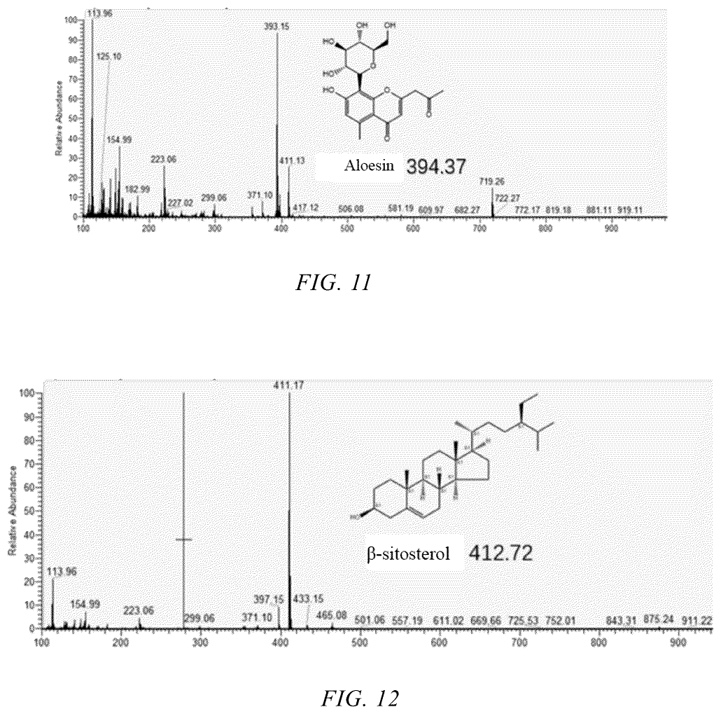

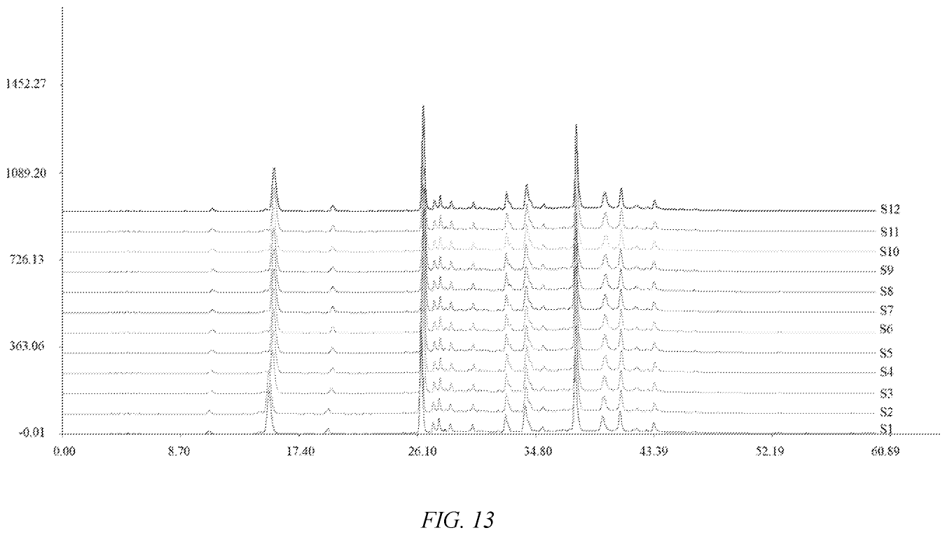

(4) The chromatograms (FIG. 13) of the test solutions of the 12 batches of new compound aloe capsules obtained in the step (3) were exported and imported into a similarity evaluation system (2004A version) for chromatographic fingerprint spectra of Chinese medicines, chromatographic peaks existing in all the chromatograms of the different batches of new compound aloe capsules were selected as common peaks, a relative retention time and a relative peak area of each of the common peaks were calculated, a reference fingerprint spectrum was generated, and chemical components of peaks in the reference fingerprint spectrum were labeled according to retention times in the chromatograms (FIG. 7 to FIG. 9) of the individual reference solutions obtained in the step (2). To determine and supplement more chemical components in the fingerprint spectrum, mass spectrometry analysis was carried out on the test solution using a DIONEX UltiMate 3000 ultra performance liquid chromatography-Orbitrap mass spectrometer under test conditions including electrospray ionization (ESI), a spray voltage of 3500 V, a sheath gas flow rate of 40 arb, an auxiliary gas flow rate of 10 arb, an auxiliary air temperature of 300° C., a capillary temperature of 300° C., a full scan mode, and a mass-to-charge ratio m/z of 100-1300. A total ion chromatogram and mass spectra of six chemical components (as shown in FIG. 10 to FIG. 12) were obtained. The test data was imported into Xcalibur software and Qual Browser was opened to carry out a data analysis of peak characteristics of chemical components. Through comparison, six main components were identified, namely, peak 4, peak 5, peak 6, peak 8, peak 14 and peak 15, respectively corresponding to tryptanthrin, aloesin, barbaloin, β-sitosterol, aloe-emodin, and indirubin. In this way, the fingerprint of the new compound aloe capsule was obtained.

(5) Similarity Analysis:

12 batches of new compound aloe capsules were taken to prepare test solutions, which were tested according to the above fingerprint spectrum determination method. The obtained fingerprint spectrum was matched against the reference fingerprint spectrum of new compound aloe capsules, three-point correction was carried out, and the similarity between the fingerprint spectrum of each batch of samples and the reference fingerprint spectrum was calculated. The similarities between the fingerprint spectra of the 12 batches of new compound aloe capsules and the reference fingerprint spectrum were all greater than or equal to 0.85 (Table 6). The results show that the similarities between different batches of new compound aloe capsules and the reference fingerprint spectrum were high, indicating that the method is stable, reliable, and adaptable, and can well test and evaluate the quality of new compound aloe capsules.

TABLE 6
Similarity analysis result

| | S1 | S2 | S3 | S4 | S5 | S6 | S7 | S8 | S9 | S10 | S11 | S12 | Control |
|---|---|---|---|---|---|---|---|---|---|---|---|---|---|
| S1 | 1 | 0.999 | 0.997 | 0.955 | 0.956 | 0.955 | 0.954 | 0.954 | 0.949 | 0.950 | 0.949 | 0.996 | 0.963 |
| S2 | 0.999 | 1 | 0.998 | 0.996 | 0.997 | 0.969 | 0.949 | 0.995 | 0.989 | 0.993 | 0.988 | 0.948 | 0.962 |
| S3 | 0.950 | 0.998 | 1 | 0.999 | 0.997 | 0.997 | 0.997 | 0.996 | 0.995 | 0.996 | 0.997 | 0.997 | 0.987 |
| S4 | 0.955 | 0.946 | 0.999 | 1 | 0.997 | 0.997 | 0.997 | 0.997 | 0.996 | 0.997 | 0.998 | 0.998 | 0.987 |
| S5 | 0.956 | 0.947 | 0.997 | 0.997 | 1 | 1 | 1 | 1 | 0.999 | 1 | 0.999 | 0.999 | 0.988 |
| S6 | 0.958 | 0.996 | 0.997 | 0.997 | 1 | 1 | 1 | 1 | 0.999 | 1 | 0.999 | 0.999 | 0.988 |
| S7 | 0.976 | 0.945 | 0.997 | 0.997 | 1 | 1 | 1 | 1 | 0.999 | 1 | 0.999 | 0.999 | 0.988 |
| S8 | 0.956 | 0.945 | 0.996 | 0.997 | 1 | 1 | 1 | 1 | 0.999 | 1 | 0.999 | 0.999 | 0.988 |
| S9 | 0.943 | 0.948 | 0.995 | 0.996 | 0.999 | 0.999 | 0.999 | 0.999 | 1 | 0.999 | 0.999 | 0.999 | 0.986 |
| S10 | 0.954 | 0.943 | 0.996 | 0.997 | 1 | 1 | 1 | 1 | 0.999 | 1 | 0.999 | 1 | 0.988 |
| S11 | 0.996 | 0.948 | 0.997 | 0.998 | 0.999 | 0.999 | 0.999 | 0.999 | 0.999 | 0.999 | 1 | 1 | 0.987 |
| S12 | 0.976 | 0.988 | 0.997 | 0.998 | 0.999 | 0.999 | 0.999 | 0.999 | 0.999 | 1 | 1 | 1 | 0.987 |
| Control | 0.963 | 0.922 | 0.987 | 0.987 | 0.988 | 0.988 | 0.988 | 0.988 | 0.986 | 0.988 | 0.987 | 0.987 | 1 |

6. Methodological Investigation

\textcircled{1} Precision Research

A test solution was prepared according to the step (1). The sample solution was injected for 6 times continuously. A fingerprint spectrum was determined according to the chromatographic conditions in the step (3), the first common peak barbaloin was selected as the standard peak (S) for comparison of retention times and relative peak areas. The results (see Tables 7 and 8) show that the relative standard deviation (RSD) of the relative retention time of each common peak was less than or equal to 0.20%, and the RSD of the relative peak area of each common peak was less than or equal to 0.50%, indicating that the fingerprint spectrum obtained under such chromatographic conditions was of good precision.

TABLE 7
Precision test result (retention time)

| No. | Barbaloin | Aloe-emodin | Indirubin |
|---|---|---|---|
| 1 | 26.491 | 39.732 | 41.016 |
| 2 | 26.590 | 39.814 | 41.078 |
| 3 | 26.512 | 39.857 | 41.077 |
| 4 | 26.549 | 39.899 | 41.108 |
| 5 | 26.561 | 39.895 | 41.075 |
| 6 | 26.593 | 39.918 | 41.075 |
| RSD (%) | 0.15 | 0.17 | 0.07 |

TABLE 8
Precision test result (peak area A)

| No. | Barbaloin | Aloe-emodin | Indirubin |
|---|---|---|---|
| 1 | 6305373 | 2434701 | 2116454 |
| 2 | 6305539 | 2468912 | 2107435 |
| 3 | 6314225 | 2452652 | 2120430 |
| 4 | 6317840 | 2447036 | 2106620 |
| 5 | 6339641 | 2439417 | 2109180 |
| 6 | 6356571 | 2453858 | 2107298 |
| RSD (%) | 0.33 | 0.49 | 0.27 |

\textcircled{2} Repeatability Test

A same batch of new compound aloe capsules were taken. Six test solutions were prepared according to the step (1). Fingerprint spectra were determined according to the chromatographic conditions in the step (3), and comparison of retention times and comparison of relative peak areas were carried out in sequence. The results (see Tables 9 and 10) show that the RSD of the relative retention time of each common peak was less than or equal to 0.10%, and the RSD of the relative peak area of each common peak was less than or equal to 1.00%, indicating good repeatability under such chromatographic conditions.

TABLE 9
Repeatability test result (retention time)

| No. | Barbaloin | Aloe-emodin | Indirubin |
|---|---|---|---|
| 1 | 26.602 | 39.920 | 41.066 |
| 2 | 26.616 | 39.933 | 41.069 |
| 3 | 26.613 | 39.925 | 41.055 |
| 4 | 26.612 | 39.953 | 41.096 |
| 5 | 26.577 | 39.919 | 41.108 |
| 6 | 26.567 | 39.908 | 41.102 |
| RSD (%) | 0.07 | 0.04 | 0.05 |

TABLE 10
Repeatability test result (peak area A)

| No. | Barbaloin | Aloe-emodin | Indirubin |
|---|---|---|---|
| 1 | 6356406 | 2481883 | 2098005 |
| 2 | 6356967 | 2486220 | 2092132 |
| 3 | 6339437 | 2439862 | 2044899 |
| 4 | 6364607 | 2507792 | 2091244 |
| 5 | 6338820 | 2473711 | 2090349 |
| 6 | 6329836 | 2484138 | 2086802 |
| RSD (%) | 0.21 | 0.90 | 0.93 |

\textcircled{3} Stability Test

A test solution was prepared according to the step (1). The test solution was taken at 0, 2, 4, 8, 16, and 24 h respectively for analysis according to the determined standard chromatographic conditions, and comparison of retention times and comparison of relative peak areas were carried out respectively. The results (see Tables 11 and 12) show that the RSD of the relative retention time of each common peak was less than or equal to 0.16%, and the RSD of the relative peak area of each common peak was less than or equal to 0.85%, indicating that the test solution had good system stability within 24 h.

TABLE 11
Stability test result (retention time)

| No. | Barbaloin | Aloe-emodin | Indirubin |
|---|---|---|---|
| 0 h | 26.577 | 39.924 | 41.087 |
| 2 h | 26.616 | 39.933 | 41.086 |
| 4 h | 26.614 | 39.935 | 41.078 |
| 8 h | 26.589 | 39.956 | 41.085 |
| 16 h | 26.701 | 39.928 | 41.078 |
| 24 h | 26.645 | 39.956 | 41.096 |
| RSD (%) | 0.16 | 0.03 | 0.02 |

TABLE 12
Stability test result (peak area A)

| No. | Barbaloin | Aloe-emodin | Indirubin |
|---|---|---|---|
| 0 h | 6356406 | 2471323 | 2088006 |
| 2 h | 6355678 | 2480929 | 2079898 |
| 4 h | 6357952 | 2450986 | 2090387 |
| 8 h | 6364556 | 2507792 | 2083769 |
| 16 h | 6325568 | 2473712 | 2098736 |
| 24 h | 6335666 | 2497921 | 2083797 |
| RSD (%) | 0.24 | 0.82 | 0.32 |

The above test results show that the fingerprint spectrum determination method for a new compound aloe capsule according to the present invention has the characteristics of good stability, high precision, and good repeatability, and can comprehensively and objectively evaluate the quality of new compound aloe capsules, to provide quality assurance for the clinical efficacy.

The above description is merely preferred embodiments of the present invention, and is not intended to limit the present invention. The protection scope of the present invention is defined by the claims. To those having ordinary skill in the art, various modifications and variations may be made to the present invention. Any modifications, equivalent substitutions and improvements made within the concept and principle of the present invention shall fall within the scope of the present invention.

What is claimed is:

1. A fingerprint spectrum construction method for a new compound aloe capsule, comprising:
(1) taking powder of a new compound aloe capsule, carrying out reflux extraction, adding methanol, carrying out ultrasonic treatment, filtering, and taking a subsequent filtrate as a test solution; dissolving barbaloin, aloe-emodin, indirubin, tryptanthrin, aloesin, and β-sitosterol in methanol to obtain reference solutions;
(2) injecting the test solution and the reference solutions into a high performance liquid chromatograph for gradient elution to obtain a chromatogram of the new compound aloe capsule and chromatograms of the reference solutions, respectively; and
(3) labeling chemical components of peaks on the chromatogram of the new compound aloe capsule according to the chromatogram of the new compound aloe capsule and the chromatograms of the reference solutions to obtain a fingerprint spectrum of the new compound aloe capsule.

2. The fingerprint spectrum construction method for a new compound aloe capsule according to claim 1, wherein in the step (2), a mobile phase used in the gradient elution comprises: acetonitrile and 0.08% aqueous phosphoric acid solution.

3. The fingerprint spectrum construction method for a new compound aloe capsule according to claim 2, wherein in the step (2), an elution procedure is shown in a table below:

| Time | | 0.08% aqueous phosphoric |
|---|---|---|
| (min) | Acetonitrile | acid solution |
| 0-5 | 10 | 90 |
| 5-15 | 15 | 85 |
| 15-20 | 20 | 80 |
| 20-30 | 25 | 75 |
| 30-40 | 30 | 70 |
| 40-50 | 40 | 60 |
| 50-60 | 50 | 50 |

4. The fingerprint spectrum construction method for a new compound aloe capsule according to claim 1, wherein in the step (2), the chromatograms are determined at a wavelength of 300 nm.

5. The fingerprint spectrum construction method for a new compound aloe capsule according to claim 1, wherein in the step (2), a chromatographic column used in the high performance liquid chromatograph is Hypersil ODS (C18).

6. The fingerprint spectrum construction method for a new compound aloe capsule according to claim 1, further comprising: carrying out mass spectrometry analysis on the test solution to obtain a mass spectrum,
wherein in the step (3), the chemical components of the peaks on the chromatogram of the new compound aloe capsule are labeled according to the chromatogram of the new compound aloe capsule, the chromatograms of the reference solutions, and the mass spectrum, to obtain the fingerprint spectrum of the new compound aloe capsule.

7. The fingerprint spectrum construction method for a new compound aloe capsule according to claim 1, further comprising: obtaining chromatograms of different batches of new compound aloe capsules and importing the chromatograms into a similarity evaluation system for chromatographic fingerprint spectra of Chinese medicines, selecting chromatographic peaks existing in all the chromatograms of the different batches of new compound aloe capsules as common peaks, calculating a relative retention time and a relative peak area of each of the common peaks, generating a reference fingerprint spectrum, and labeling chemical components of the common peaks in the reference fingerprint spectrum according to retention times in the chromatograms of the reference solutions; and calculating a similarity between the fingerprint spectrum of the new compound aloe capsule and the reference fingerprint spectrum, to determine reliability of the fingerprint spectrum of the new compound aloe capsule.

8. The fingerprint spectrum construction method for a new compound aloe capsule according to claim 1, wherein the fingerprint spectrum of the new compound aloe capsule has six characteristic peaks, comprising peak 4, peak 5, peak 6, peak 8, peak 14 and peak 15, respectively corresponding to tryptanthrin, aloesin, barbaloin, β-sitosterol, aloe-emodin, and indirubin.

9. A fingerprint spectrum of a new compound aloe capsule obtained by the construction method according to claim 1.
